(19) United States
(12) Patent Application Publication
(10) Pub. No.: US 2025/0236413 A1
(43) Pub. Date: Jul. 24, 2025

(54) SYSTEMS AND METHODS FOR INCREASING OPERATIONAL EFFICIENCY OF AIRCRAFT

(71) Applicant: THE BOEING COMPANY, Arlington, VA (US)

(72) Inventor: Scott Philip Young, Reston, VA (US)

(73) Assignee: THE BOEING COMPANY, Arlington, VA (US)

(21) Appl. No.: 18/421,069

(22) Filed: Jan. 24, 2024

(51) Int. Cl. B64D 45/00

(52) U.S. Cl. CPC B64D 45/00; B64D 2045/0085

(57) ABSTRACT

A system and a method include a control unit configured to monitor operational aspects of an aircraft during a flight, determine one or more changes to one or more of the operational aspects to improve an efficiency of an operation of the aircraft during the flight, and output an advisory to the aircraft during the flight. The advisory includes the one or more changes to the one or more of the operational aspects. The aircraft is operated according to the changes to the one or more of the operational aspects.

### FIELD OF THE DISCLOSURE

Examples of the present disclosure generally relate to systems and methods for increasing operational efficiency of aircraft.

### BACKGROUND OF THE DISCLOSURE

Aircraft are used to transport passengers and cargo between various locations. Numerous aircraft depart from and arrive at a typical airport every day.

Pilots typically receive information from numerous data sources before and during a flight. For example, pilots receive Notice to Air Missions (NOTAMs), airport notes, current weather conditions, airline-specific briefing content, and/or the like. As such, pilots sift through the information to determine what is uniquely relevant to a particular flight.

Aircraft operators can become overwhelmed with various services configured to increase operational efficiency of aircraft. Known services are typically based on generic airplane models. Known services are generally limited to a single or small number of optimization solutions, requiring airlines to utilize multiple applications to achieve all potential optimization opportunities. Additionally, other services typically require significant amount of flight crew interactions to increase operational efficiency. For example, a pilot may need to continually use a service throughout a flight to determine if one or more operational changes can increase flight efficiency.

### SUMMARY OF THE DISCLOSURE

A need exists for an improved system and method for increasing operational efficiency of an aircraft. Further, a need exists for a system and a method which require less attention from a pilot, thereby allowing the pilot to focus on operating the aircraft. Additionally, a need exist for a system and a method that are tailored to a specific aircraft, instead of a generic model. A need also exists for a system and a method for providing improved operational efficiency at a correct time that allows a pilot to operate the aircraft accordingly.

With those needs in mind, certain examples of the present disclosure provide a system including a control unit configured to monitor operational aspects of an aircraft during a flight, determine one or more changes to one or more of the operational aspects to improve an efficiency of an operation of the aircraft during the flight, and output an advisory to the aircraft during the flight. The advisory includes the one or more changes to the one or more of the operational aspects. The aircraft is operated according to the changes to the one or more of the operational aspects.

In at least one example, the control unit is configured to automatically output the advisory without human intervention.

In at least one example, the control unit is remote from the aircraft.

The operational aspects can include one or more of (individually or in combination) airspeed, altitude, route, or cost index. As a further example, the operational aspects include the airspeed, the altitude, the route, and the cost index.

In at least one example, the control unit is further configured to show the advisory on a display of a user interface of the aircraft.

In at least one example, the control unit is configured to output the advisory in response to the one or more changes meeting one or more aspect deviation thresholds.

The control unit can be further configured to automatically operate the aircraft according to the changes to the one or more of the operational aspects.

The control unit can be an artificial intelligence or machine learning system.

Certain examples of the present disclosure provide a method including monitoring, by a control unit, operational aspects of an aircraft during a flight; determining, by the control unit, one or more changes to one or more of the operational aspects to improve an efficiency of an operation of the aircraft during the flight; and outputting, by the control unit, an advisory to the aircraft during the flight.

Certain examples of the present disclosure provide a non-transitory computer-readable storage medium comprising executable instructions that, in response to execution, cause one or more control units comprising a processor, to perform operations comprising: monitoring operational aspects of an aircraft during a flight; determining one or more changes to one or more of the operational aspects to improve an efficiency of an operation of the aircraft during the flight; and outputting an advisory to the aircraft during the flight.

### BRIEF DESCRIPTION OF THE DRAWINGS

FIG. 1 illustrates a block diagram of a system, according to an example of the present disclosure.

FIG. 2 illustrates a flow chart of a method, according to an example of the present disclosure.

FIG. 3 illustrates a schematic block diagram of a control unit, according to an example of the present disclosure.

FIG. 4 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

As described herein, examples of the present disclosure provide systems and method that include a control unit, such as at a ground-based monitoring center that is remote from an aircraft. The control unit is configured to provide efficient operational aspects to a pilot of the aircraft, thereby increasing operational and fuel efficiencies for, and reducing emissions of, the aircraft. The control unit can utilize cloud-based analytics, artificial intelligence, machine learning, and/or the like to provide optimization recommendations to operators of aircraft. Such recommendations enable aircraft to operate more efficiently, thereby saving fuel and reducing emissions.

In at least one example, the control unit uses tail-specific data to generate operational benefits for specific aircraft. The control unit outputs advisories, which provide information on altering one or more flight aspects (such as airspeed, altitude, route, cost index, and/or the like) to increase efficiency (for example, reduce fuel burn and/or reduce flight time) of the aircraft. The control unit automatically determines operational efficiencies regarding one or more flight aspects, and automatically outputs the advisory including the operational efficiencies to pilots, thereby greatly reducing crew workload, and improving overall crew utilization.

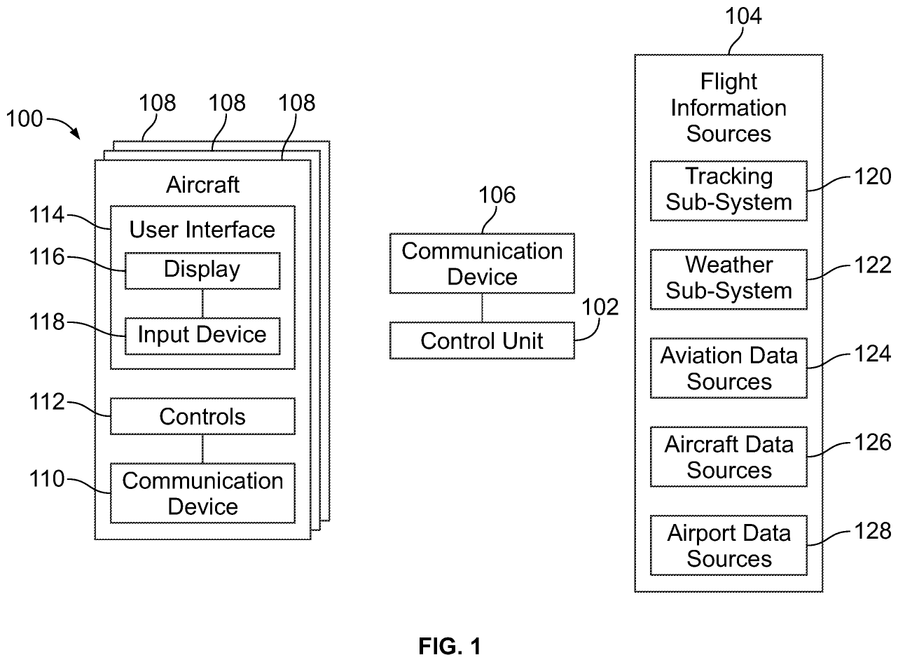

FIG. 1 illustrates a block diagram of a system 100, according to an example of the present disclosure. The system 100 includes a control unit 102 in communication with a plurality of flight information sources 104, such as through one or more wired or wireless connections. For example, the control unit 102 can be coupled to a communication device 106 that receives data from the flight information sources 104. The communication device 106 can be one or more of an antenna, a transceiver, an internet connection, a cloud-based connection, and/or the like.

The control unit 102 is also in communication with one or more aircraft 108, such as via communication between the communication device 106 and a communication device 110 of the aircraft 108. The communication device 110 can be an antenna, a transceiver, an internet connection, a cloud-based connection, and/or the like. In at least one example, control unit 102 is separate and distinct from the aircraft 108. For example, the control unit 102 can be located at a central monitoring location, which can be remote from, or optionally co-located with, one or more of the flight information sources 104. As another example, the control unit 102 can be onboard the aircraft 108, such as within a flight deck or cockpit. For example, the control unit 102 can communicate with a flight computer of the aircraft 108.

The aircraft 108 includes controls 112 configured to allow an operator, such as a pilot, to control operation of the aircraft 108. For example, the controls 112 include one or more of a control handle, yoke, joystick, control surface controls, accelerators, decelerators, and/or the like.

The aircraft 108 also includes a user interface 114, such as within a flight deck or cockpit of the aircraft 108. The user interface 114 includes a display 116 and an input device 118. The display 116 can be a monitor, screen, television, touchscreen, and/or the like. The input device 118 can include a keyboard, mouse, stylus, touchscreen interface (that is, the input device 118 can be integral with the display 116), and/or the like. The user interface 114 can be, or part of, a computer workstation. For example, the user interface 114 can be part of the flight computer within the flight deck or cockpit of the aircraft 108. As another example, the user interface 114 can be a handheld device, such as a smart phone, tablet, or the like.

In at least one example, the control unit 102 can be in communication with a user interface 114 that is not onboard an aircraft 108, in addition to (or optionally instead of) the user interface 114 onboard one or more aircraft 108. For example, the user interface 114 can be at a land-based monitoring location, such as with respect to air traffic control, a flight dispatcher, an airline operations center, and/or the like.

In operation, the control unit 102 receives data (for example, aviation data) from the flight information sources 104. The data includes vast amounts of information from numerous different flight information sources 104. The flight information sources 104 include a tracking sub-system 120, which is configured to track the aircraft 108. In at least one example, the tracking sub-system 120 is configured to track positions of the aircraft 108 in real time. In at least one example, the tracking sub-system 120 is a radar sub-system. As another example, the tracking sub-system is an automatic dependent surveillance-broadcast (ADS-B) tracking sub-system. Real time positions of the aircraft 108 on the ground and within an airspace are detected by the tracking sub-system 120 that receives position signals output by a position sensor of the aircraft 108. For example, the tracking sub-system 120 receives ADS-B signals output by the position sensors of the aircraft 108. As another example, the position sensor of the aircraft 108 can be global positioning system sensors. The position sensor outputs signals indicative of one or more of the position, altitude, heading, acceleration, velocity, and/or the like of the aircraft 108. The signals are received by the tracking sub-system 120.

The flight information sources 104 also include a weather sub-system 122, which provides past, current, and predicted weather for locations of the aircraft 108, airports, and the like. As an example, the weather sub-system 122 can include a weather station, channel, or the like. As another example, the weather sub-system 122 can include aeronautical weather services that provide weather notifications at various locations, such as airports. An example of data from a weather sub-system 122 includes a meteorological aerodrome report (METAR).

The flight information sources 104 also include aviation data sources 124, which provide information regarding aviation flight operations. Non-limiting examples of the aviation data sources 124 includes NOTAMs, aircraft communication addressing and reporting system (ACARS), Digital Automatic Terminal Information Service (D-ATIS), Pilot Reports (PIREPs), and/or the like.

In at least one example, the aviation data sources 124 includes a flight route for an aircraft 108. The flight route includes information regarding a flight for an aircraft from a departure airport to an arrival airport, including a path therebetween, altitudes at various flight phases, airspeeds at various phases, progress along a flight path, and the like.

The flight information sources 104 also include aircraft data sources 126, which provide information about various aircraft. For example, the aircraft data sources 126 include information regarding a type and capabilities of the aircraft 108. The aircraft data sources 126 can be information provided by a manufacturer, maintenance provider, operator, and/or the like of the aircraft 108.

In at least one example, the aircraft data sources 126 provide tail-specific information regarding the aircraft 108. The tail-specific information for the aircraft 108 provides information regarding the performance of the specific, actual aircraft, in contrast to a different test aircraft, a general performance model, or the like.

The flight information sources 104 also include airport data sources 128, which provide information regarding an airport, such as a departure airport and/or an arrival airport for the aircraft 108. The airport data sources 128 can include airport map data, including locations of runways, taxiways, gates, and the like. Optionally, the airport data sources 128 may not include airport map data.

In operation, the control unit 102 receives a flight plan for the aircraft 108, such as from the aircraft 108 itself, or from a flight information source 104, such as an aviation data source 124. The flight plan includes various operational aspects for the aircraft 108 between a departure airport and an arrival airport. The operational aspects include a flight route between the airports, altitudes at various flight phases (such as ascent, cruise, descent, and the like), airspeeds at the various flight phases, cost index for the various flight phases, and the like.

During a flight of the aircraft 108, the control unit 102 continually monitors the aircraft 108, such as via the tracking sub-system 120, as well as other aspects such as the weather, air traffic, and the like through various other flight information sources 104. The control unit 102 compares the current operation of the aircraft 108, such as according to the flight plan, with flight information from flight information sources 104 to determine whether operational efficiency can be improved. As an example, based on the tail-specific information for the aircraft 108 (such as received form the aviation data sources 124), the control unit 102 can determine that operating the aircraft at a different cost index (such as 38 instead of 30) results in increased operational efficiency. As another example, the control unit 102 can determine that altering a route of the aircraft 108 to avoid air turbulence determined from data received from the weather sub-system 122 results in increased operational efficiency. As another example, the control unit 102 can determine that operating at a different altitude results in increased operational efficiency. The aforementioned are merely examples, and various additional and/or other operational aspects can be analyzed and determined.

After the control unit 102 determines that one or more operational aspects (such as flight route, altitude, airspeed, cost index, and/or the like) can be adjusted to improve operational efficiency of the aircraft 108, the control unit 102 outputs an advisory to the aircraft 108, which can be shown on the display 116 (or broadcast through a speaker, for example). The advisory includes a message indicating one or more proposed changes to one or more operational aspects of the aircraft 108. The pilot of the aircraft 108 can then operate the aircraft 108 according to the proposed change(s) to improve the operational efficiency of the aircraft 108.

In at least one example, the control unit 102 can be configured to output an advisory in response to a change in one or more operational aspects meeting (such as equaling and/or exceeding) a predetermined aspect deviation threshold. For example, the aspect deviation threshold can be a change in altitude of more than 1000 feet. Optionally, the change in altitude can be less than 1000 feet (such as 500 feet) or more than 1000 feet (such as 5000 feet). As another example, the aspect deviation threshold can be change in airspeed of 50 miles per hour. Optionally, the change in airspeed can be less than 50 miles per hour (such as 25 miles per hour) or more than 50 miles per hour (such as 100 miles per hour). As another example, the aspect deviation threshold can be a change in route having a change in heading of +/−5 degrees. Optionally, the change in heading can be greater or less than +/−5 degrees, such as +/−2 degrees, or +/−10 degrees. As another example, the aspect deviation threshold can be a change in cost index of +/−10%. Optionally, the change in cost index can be greater or less than +/−10%, such as +/−5%, or +/−20%.

In at least one example, the control unit 102 does not output the advisory if the change(s) do not meet one or more aspect deviation thresholds. By setting aspect deviation thresholds for various operational aspects of the aircraft 108, a flight crew does not continually receive advisories from the control unit 102, which continually monitors the operational aspects of the aircraft 108. Instead, the aspect deviation thresholds allow a flight crew to be alerted to proposed changes in operational aspects, through advisories output by the control unit 102, at times determined by the pilots or airline operation crews that are beneficial, and which do not unduly distract the pilots. In at least one example, the control unit 102 can determine the aspect deviation thresholds through artificial intelligence or machine learning.

In at least one example, the control unit 102 can also be in communication with the controls 112 of the aircraft 108, and configured to automatically operate the controls 112, based on the proposed changes to the operational aspects of the aircraft 108, as determined by the control unit 102. As an example, the control unit 102 can automatically operate the aircraft 108 to avoid inclement weather as indicated in a METAR. As another example, the control unit 102 can automatically operate the aircraft 108 to avoid restricted airspace, such as set forth in a NOTAM. As another example, the control unit 102 can automatically operate the aircraft 108 to reduce airspeed in order to reduce time in a holding pattern (such as noted in a NOTAM) at a destination airport. As another example, the control unit 102 can automatically operate the aircraft 108 at a different altitude, airspeed, cost index, and/or the like to improve operational efficiency, such as to reduce fuel burn and/or reduce flight time. Optionally, the control unit 102 may not be in communication with the controls 112, and may not be configured to automatically operate the aircraft 108.

As described herein, the system 100 includes the control unit 102, which his configured to provide advisories to aircraft 108. The advisories include proposed changes to one or more operational aspects of the aircraft 108, which enable fuel savings, and reduce emissions. In at least one example, the control unit 102 is remote from the aircraft 108, and can be at a ground-based location. The control unit 102 is configured to output, such as via pushing, the advisories to the aircraft 108 in real time. The control unit 102 can be provided as a single service, and may not require any application, extensive crew analysis, or additional equipment.

As described herein the system 100 includes the control unit 102, which is configured to monitor operational aspects of an aircraft 108 during a flight. The control unit 102 is further configured to determine one or more changes (such as through analysis of data received from one or more flight information sources 104) to one or more of the operational aspects to improve an efficiency of an operation of the aircraft 108 during the flight. The control unit 102 is further configured to output an advisory to the aircraft 108 during the flight. The advisory includes the change(s) to the operational aspect(s). The aircraft 108 is operated according to the change(s) to the operational aspect(s). In at least one example, the control unit 102 automatically outputs the advisory without human intervention.

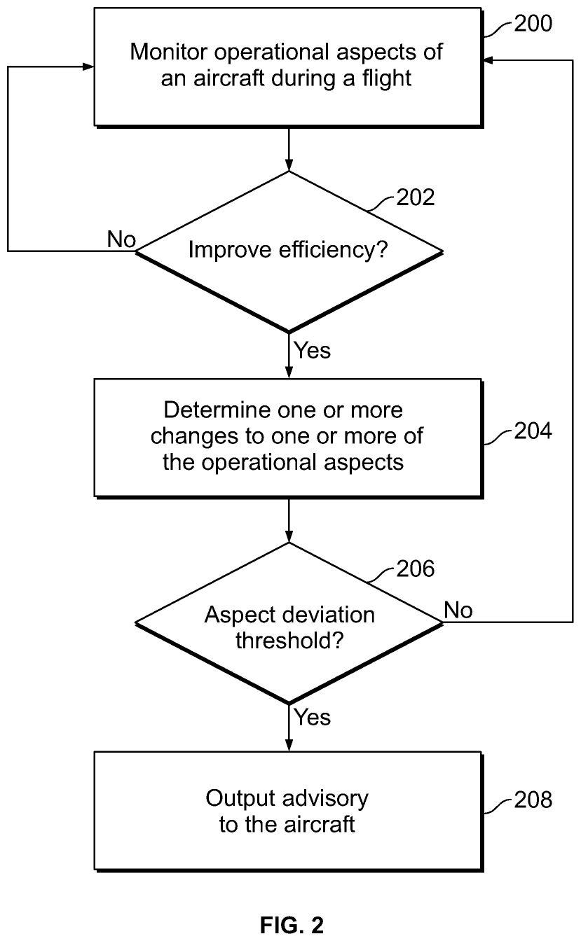

FIG. 2 illustrates a flow chart of a method, according to an example of the present disclosure. Referring to FIGS. 1 and 2, at 200, the control unit 102 monitors operational aspects of an aircraft 108 during a flight. The control unit 102 monitors the operational aspects of the aircraft 108 through data received from various flight information sources 104 (non-limiting examples of which are shown in FIG. 1). At 202, the control unit 102 then determines if efficiency of operation of the aircraft 108 can be improved. For example, the control unit 102 compares the current operational aspects of the aircraft 108 with the data received from the flight information sources 104 to determine if the efficiency can be improved. If the efficiency cannot be improved, the method returns to 200.

If, however, the efficiency of the operation of the aircraft 108 can be improved at 202, the method proceeds to 204, at which the control unit 102 determines one or more changes to one of the operational aspects to improve the efficiency. At 206, the control unit 102 then determines if the change(s) meets a relevant aspect deviation threshold. If not, the method returns to 200. If, however, the change(s) meets a relevant aspect deviation threshold, the method proceeds from 206 to 208, at which the control unit 102 outputs an advisory (including one or more proposed changes to the operational aspect(s)) to the aircraft 108. The pilot can then operate the aircraft 108 according to the proposed change(s). Optionally, the aircraft 108 can be automatically operated, such as by the control unit 102, according to the proposed change(s).

In at least one example, the control unit 102 automatically outputs the advisory without human intervention. For example, the control unit 102 does not send an advisory in response to a request from a pilot. Instead, the control unit 102 automatically pushes the advisory to the pilot.

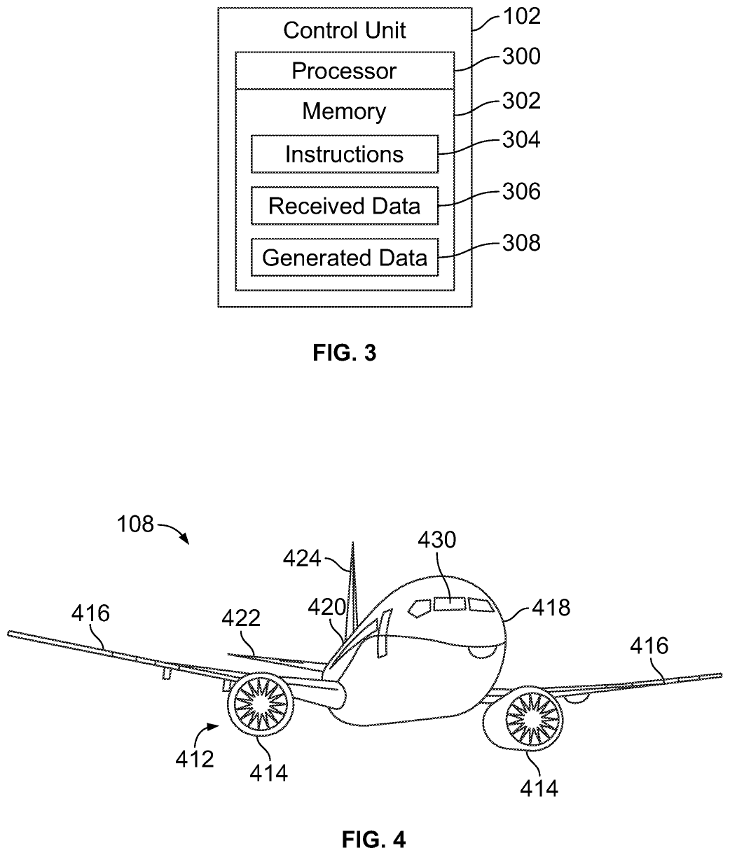

FIG. 3 illustrates a schematic block diagram of the control unit 102, according to an example of the present disclosure. In at least one example, the control unit 102 includes at least one processor 300 in communication with a memory 302. The memory 302 stores instructions 304, received data 306, and generated data 308. The control unit 102 shown in FIG. 3 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-3, examples of the subject disclosure provide systems and methods that allow large amounts of data to be quickly and efficiently analyzed by a computing device. For example, the control unit 102 can receive and analyze data from hundreds, thousands, or more flight information sources 104 over days, weeks, months, or years. As such, large amounts of data, which may not be readily discernable by human beings, are being tracked and analyzed. The vast amounts of data are efficiently organized and/or analyzed by the control unit 102, as described herein. The control unit 102 analyzes the data in a relatively short time in order to quickly and efficiently determine changes to operational aspects and output relevant advisories to the aircraft 108. As such, examples of the present disclosure provide increased and efficient functionality, and vastly superior performance in relation to a human being reviewing the vast amounts of data.

In at least one example, components of the system 100, such as the control unit 102, provide and/or enable a computer system to operate as a special computer system for improving operational efficiency of an aircraft 108. The control unit 102 improves upon standard computing devices by determining such information and automatically communicating with pilots in an efficient and effective manner.

In at least one example, all or part of the systems and methods described herein are or otherwise include an artificial intelligence (AI) or machine-learning system that can automatically perform the operations of the methods also described herein. In at least one example, the control unit 102 can be or otherwise include a deterministic or rules based evaluation system. In at least one example, the control unit 102 can be an artificial intelligence or machine learning system. These types of systems may be trained from outside information and/or self-trained to repeatedly improve the accuracy with how data is analyzed to determine and present the relevant information to users, such as pilots and dispatchers. For example, an AI control unit 102 can be trained to learn aspect deviation thresholds, efficient changes in operational aspects, and the like, such as based on tail-specific capabilities of aircraft, preferences and habits of pilots, and the like. Over time, these systems can improve by determining and communicating with increasing accuracy and speed, thereby significantly reducing the likelihood of any potential errors. For example, the AI or machine-learning systems can learn and determine models, associate such models with received data, and determine potential conflicts. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determinations and communications described herein. The training minimizes conflicts and interference by performing an iterative training algorithm, in which the systems are retrained with an updated set of data, and based on the feedback examined prior to the most recent training of the systems. This provides a robust analysis model that can better determine and present relevant information to a pilot.

FIG. 4 illustrates a perspective front view of an aircraft 108, according to an example of the present disclosure. The aircraft 108 includes a propulsion system 412 that includes engines 414, for example. Optionally, the propulsion system 412 may include more engines 414 than shown. The engines 414 are carried by wings 416 of the aircraft 108. In other examples, the engines 414 may be carried by a fuselage 418 and/or an empennage 420. The empennage 420 may also support horizontal stabilizers 422 and a vertical stabilizer 424. The fuselage 418 of the aircraft 108 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 4 shows an example of an aircraft 108. It is to be understood that the aircraft 108 can be sized, shaped, and configured differently than shown in FIG. 4.

Further, the disclosure comprises examples according to the following clauses:

Clause 1. A system comprising:
a control unit configured to:
   monitor operational aspects of an aircraft during a flight,
   determine one or more changes to one or more of the operational aspects to improve an efficiency of an operation of the aircraft during the flight, and
   output an advisory to the aircraft during the flight, wherein the advisory includes the one or more changes to the one or more of the operational aspects, and wherein the aircraft is operated according to the changes to the one or more of the operational aspects.

Clause 2. The system of Clause 1, wherein the control unit is configured to automatically output the advisory without human intervention.

Clause 3. The system of Clauses 1 or 2, wherein the control unit is remote from the aircraft.

Clause 4. The system of any of Clauses 1-3, wherein the operational aspects comprise one or more of airspeed, altitude, route, or cost index.

Clause 5. The system of Clause 4, wherein the operational aspects comprise the airspeed, the altitude, the route, and the cost index.

Clause 6. The system of any of Clauses 1-5, wherein the control unit is further configured to show the advisory on a display of a user interface of the aircraft.

Clause 7. The system of any of Clauses 1-6, wherein the control unit is configured to output the advisory in response to the one or more changes meeting one or more aspect deviation thresholds.

Clause 8. The system of any of Clauses 1-7, wherein the control unit is further configured to automatically operate the aircraft according to the changes to the one or more of the operational aspects.

Clause 9. The system of any of Clauses 1-8, wherein the control unit is an artificial intelligence or machine learning system.

Clause 10. A method comprising:
monitoring, by a control unit, operational aspects of an aircraft during a flight,
determining, by the control unit, one or more changes to one or more of the operational aspects to improve an efficiency of an operation of the aircraft during the flight, and
outputting, by the control unit, an advisory to the aircraft during the flight, wherein the advisory includes the one or more changes to the one or more of the operational aspects, and
wherein the aircraft is operated according to the changes to the one or more of the operational aspects.

Clause 11. The method of Clause 10, wherein said outputting comprises automatically outputting the advisory without human intervention.

Clause 12. The method of Clauses 10 or 11, wherein the control unit is remote from the aircraft.

Clause 13. The method of any of Clauses 10-12, wherein the operational aspects comprise one or more of airspeed, altitude, route, or cost index.

Clause 14. The method of Clause 13, wherein the operational aspects comprise the airspeed, the altitude, the route, and the cost index.

Clause 15. The method of any of Clauses 10-14, further comprising showing, by the control unit, the advisory on a display of a user interface of the aircraft.

Clause 16. The method of any of Clauses 10-15, wherein said outputting is in response to the one or more changes meeting one or more aspect deviation thresholds.

Clause 17. The method of any of Clauses 10-16, further comprising automatically operating the aircraft according to the changes to the one or more of the operational aspects.

Clause 18. The method of any of Clauses 10-17, wherein the control unit is an artificial intelligence or machine learning system.

Clause 19. A non-transitory computer-readable storage medium comprising executable instructions that, in response to execution, cause one or more control units comprising a processor, to perform operations comprising:
monitoring operational aspects of an aircraft during a flight,
determining one or more changes to one or more of the operational aspects to improve an efficiency of an operation of the aircraft during the flight, and
outputting an advisory to the aircraft during the flight, wherein the advisory includes the one or more changes to the one or more of the operational aspects, and
wherein the aircraft is operated according to the changes to the one or more of the operational aspects.

Clause 20. The non-transitory computer-readable storage medium of claim 19, wherein said outputting is in response to the one or more changes meeting one or more aspect deviation thresholds.

As described herein, examples of the present disclosure provide improved systems and methods for increasing operational efficiency of an aircraft. Further, examples of the present disclosure provide systems and methods which require less attention from a pilot, thereby allowing the pilot to focus on operating the aircraft. Additionally, examples of the present disclosure provide systems and methods that are tailored to a specific aircraft, instead of a generic model.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit configured to:
monitor operational aspects of an aircraft during a flight,
determine one or more changes to one or more of the operational aspects to improve an efficiency of an operation of the aircraft during the flight, and
output an advisory to the aircraft during the flight, wherein the advisory includes the one or more changes to the one or more of the operational aspects, and wherein the aircraft is operated according to the changes to the one or more of the operational aspects.

2. The system of claim 1, wherein the control unit is configured to automatically output the advisory without human intervention.

3. The system of claim 1, wherein the control unit is remote from the aircraft.

4. The system of claim 1, wherein the operational aspects comprise one or more of airspeed, altitude, route, or cost index.

5. The system of claim 4, wherein the operational aspects comprise the airspeed, the altitude, the route, and the cost index.

6. The system of claim 1, wherein the control unit is further configured to show the advisory on a display of a user interface of the aircraft.

7. The system of claim 1, wherein the control unit is configured to output the advisory in response to the one or more changes meeting one or more aspect deviation thresholds.

8. The system of claim 1, wherein the control unit is further configured to automatically operate the aircraft according to the changes to the one or more of the operational aspects.

9. The system of claim 1, wherein the control unit is an artificial intelligence or machine learning system.

10. A method comprising:
monitoring, by a control unit, operational aspects of an aircraft during a flight;
determining, by the control unit, one or more changes to one or more of the operational aspects to improve an efficiency of an operation of the aircraft during the flight; and
outputting, by the control unit, an advisory to the aircraft during the flight, wherein the advisory includes the one or more changes to the one or more of the operational aspects, and
wherein the aircraft is operated according to the changes to the one or more of the operational aspects.

11. The method of claim 10, wherein said outputting comprises automatically outputting the advisory without human intervention.

12. The method of claim 10, wherein the control unit is remote from the aircraft.

13. The method of claim 10, wherein the operational aspects comprise one or more of airspeed, altitude, route, or cost index.

14. The method of claim 13, wherein the operational aspects comprise the airspeed, the altitude, the route, and the cost index.

15. The method of claim 10, further comprising showing, by the control unit, the advisory on a display of a user interface of the aircraft.

16. The method of claim 10, wherein said outputting is in response to the one or more changes meeting one or more aspect deviation thresholds.

17. The method of claim 10, further comprising automatically operating the aircraft according to the changes to the one or more of the operational aspects.

18. The method of claim 10, wherein the control unit is an artificial intelligence or machine learning system.

19. A non-transitory computer-readable storage medium comprising executable instructions that, in response to execution, cause one or more control units comprising a processor, to perform operations comprising:
monitoring operational aspects of an aircraft during a flight;
determining one or more changes to one or more of the operational aspects to improve an efficiency of an operation of the aircraft during the flight; and
outputting an advisory to the aircraft during the flight, wherein the advisory includes the one or more changes to the one or more of the operational aspects, and
wherein the aircraft is operated according to the changes to the one or more of the operational aspects.

20. The non-transitory computer-readable storage medium of claim 19, wherein said outputting is in response to the one or more changes meeting one or more aspect deviation thresholds.
